(19) United States
(12) Patent Application Publication
(10) Pub. No.: US 2021/0362282 A1
(43) Pub. Date: Nov. 25, 2021

(54) HAND-HELD POWER TOOL

(71) Applicant: Robert Bosch GmbH, Stuttgart (DE)

(72) Inventors: Tobias Herr, Stuttgart (DE); Dietmar Saur, Moessingen (DE); Heiko Roehm, Stuttgart (DE); Jens Blum, Filderstadt (DE); Michael Wieler, Schorndorf (DE); Simon Erbele, Nufringen (DE)

(21) Appl. No.: 16/976,702

(22) PCT Filed: Feb. 4, 2019
(86) PCT No.: PCT/EP2019/052587

§ 371 Date: Sep. 28, 2020

(30) Foreign Application Priority Data
Mar. 8, 2018 (DE) 10 2018 203 519.9

(51) Int. Cl. B23Q 17/24; F21V 8/00

(52) U.S. Cl. CPC B23Q 17/2404; B25F 5/00; G02B 6/0088

(57) ABSTRACT

A hand-held power tool including a drive unit. The drive unit is actuatable with the aid of at least one manual switch, The hand-held power tool also includes a housing and at least one user interface, the user interface including at least one operating element. The user interface includes at least one work location illumination unit, the work location illumination unit including at least one illuminant and at least one light guiding element.

### FIELD

The present invention relates to a hand-held power tool.

### BACKGROUND INFORMATION

A hand-held power tool including a drive unit, a housing, and at least one user interface is conventional in the related art. The drive unit is actuatable with the aid of at least one manual switch. The user interface includes at least one operating element.

### SUMMARY

The present invention is directed to a hand-held power tool including a drive unit, a housing, and at least one user interface. The drive unit is actuatable with the aid of at least one manual switch. The user interface includes at least one operating element. It is provided that the user interface includes at least one work location illumination unit, the work location illumination unit including at least one illuminant and at least one light guiding element.

The present invention provides an integrated user interface, in which an operating unit and a work location illumination unit are integrated in a module. The user interface is particularly compact and, at the same time, robust.

The hand-held power tool is, in particular, designed as a rotary impact screw driver. The rotary impact screw driver includes at least one striking mechanism, in particular, a rotary striking mechanism. During operation, the striking mechanism generates high torque peaks to thereby loosen stuck connecting means or tighten connecting means. The striking mechanism is connected to the drive motor with the aid of the gearbox. The striking mechanism is additionally connected to the output shaft.

The drive unit includes at least one drive motor and, in one specific embodiment, may include at least one gearbox. The drive motor may, in particular, be designed as at least one electric motor. The gearbox may be designed as at least one planetary gear, it being shiftable, for example. The present invention may also be used with other motor types or gearbox types. The hand-held power tool additionally includes an power supply, the power supply being provided for a rechargeable battery operation with the aid of a rechargeable battery, in particular a hand-held power tool rechargeable battery pack, and/or for a mains operation. In one preferred specific embodiment, the power supply is designed for the rechargeable battery operation. Within the scope of the present invention, a “hand-held power tool rechargeable battery pack” shall be understood to mean an integration of at least one rechargeable battery cell and a rechargeable battery pack housing. The hand-held power tool rechargeable battery pack is advantageously designed for supplying commercially available rechargeable battery-operated hand-held power tools with power. The at least one rechargeable battery cell may, for example, be designed as a Li-ion rechargeable battery cell having a nominal voltage of 3.6 V. By way of example, the hand-held power tool rechargeable battery pack may encompass up to ten rechargeable battery cells, a different number of rechargeable battery cells also being possible. A specific embodiment as a rechargeable battery-operated hand-held power tool and the operation as a mains-operated hand-held power tool are sufficiently conventional to those skilled in the art, which is why the details of the power supply are not addressed here.

The drive unit is configured in such a way that it is actuatable via the manual switch. When the manual switch is actuated by a user, the drive unit is switched on, and the hand-held power tool is put into operation. When, accordingly, the manual switch is not further actuated by the user, the drive unit is switched off. The drive unit is preferably electronically controllable and/or regulatable in such a way that a reversing operation and a specification for a desired rotational speed are implementable. It is also possible that the manual switch is a latchable manual switch, which in at least one operating state is latchable in at least one position.

The hand-held power tool includes the user interface including the operating element. In particular, the user interface is situated at the housing. The user interface may be an interface between the user and the hand-held power tool. The operating element is designed to receive inputs by the user. The operating element is advantageously used to at least set at least one operating mode, in particular, a rotational speed level, and/or to at least control and/or regulate the work location illumination unit. It is possible that the operating element is also assignable for setting an operating mode allocatable by the user. The operating element may furthermore also be used to set a further operating mode which appears useful to those skilled in the art.

The user interface may convert the inputs by the user into an, in particular electrical, signal. Thereafter, the user interface may forward the signal to a signal processing unit. The user interface may furthermore also display pieces of information with the aid of at least one display element. The user interface advantageously includes the display element. The display element is designed to display at least one piece of information about an operating state, the operating mode and/or a piece of operating information. The display element may be designed as an illuminant and/or as a display, or further display elements which appear useful to those skilled in the art. In one specific embodiment, the display element may include three LEDs for displaying the rotational speed level.

The operating state may be “switched on” or “switched off,” for example. The operating mode may, by way of example, be at least one rotational speed, at least one rotational speed level or at least one striking energy. Examples of the piece of operating information are “pairing with an electrical device,” “connected to an electrical device,” “not connected to an electrical device” or at least one battery charge state.

In addition, further examples of operating states, operating modes and/or pieces of operating information which appear useful to those skilled in the art are also possible.

In one specific embodiment of the present invention, the signal processing unit is situated in the housing of the hand-held power tool. The signal processing unit is, in particular, designed to receive signals from the user interface, and to process and output them. The signal processing unit processes the signals into at least one output signal and outputs it. The output signal may then be transmitted to the user interface and/or may control and/or regulate the drive unit. For example, the manual switch may also be connected to the signal processing unit. The signal processing unit may be designed as a microprocessor or as a microcontroller.

In a particularly advantageous manner, the user interface includes at least one further operating element. In a manner similar to the operating element, the further operating element may be used to at least set at least one operating mode, in particular, a rotational speed level, and/or to at least control and/or regulate the work location illumination unit. The operating element and/or the further operating element may switch the work location illumination unit on or off in the process, as well as, continuously or incrementally, increase or decrease a luminous output, in particular, a brightness.

The operating element is an operating element actuatable by the user, via which the user may change at least the operating state, the operating mode and/or the piece of operating information. The operating element may be designed as at least one pusher element, as at least one sliding element, as at least one rotary element, or also as at least one tilt element. Further specific embodiments of the at least one operating element are also possible. The at least one pusher element is designed to be pushed by a user. The at least one sliding element is provided to be displaced by a user. The at least one rotary element is designed to be rotated by a user. The at least one tilt element is provided to be tilted by a user. Depending on the specific embodiment, a combination of the described operating elements is also possible.

In one specific embodiment of the present invention, the operating element may include at least one printed and/or one profiled area. In particular, the printed and/or profiled area is designed on an operating surface of the operating element. The printed and/or profiled area has the task of displaying at least one function of the operating element to the user. The function is displayed on the operating surface by the printed and/or profiled area, for example in the form of an illuminant, for example a bulb, or further comparable figures, signs or the like, in the form of a hammer including a screw or in the form of a revolution counter. However, other representations of the functions of the operating element are also possible for this purpose. Due to the printed and/or profiled area, it is directly apparent to the user how the operating element may be actuated. The printed area is formed by at least one imprint on the operating surface. The profiled area is designed by ribs, grooves, protuberances or further comparable elements for displaying the function. Moreover, the profiled area is designed in such a way that a slipping of the finger of the user during an actuation of the operating element is avoided. The at least one actuation is as described above. In particular, in one preferred specific embodiment, the at least one actuation is at least a pushing of the operating element.

In one specific embodiment of the present invention, the operating element and/or the further operating element include(s) at least one return element. The return element is provided to return the operating element and/or the further operating element into at least a neutral position. The neutral position is characterized in that the operating element and/or the further operating element is/are actuatable in the neutral position. In particular, the return element has at least one returning effect, so that the operating element and/or the further operating element is/are returned into the neutral position after the at least one actuation. Thereafter, the operating element and/or the further operating element is/are situated in the neutral position, so that at least one next actuation is possible. The return element is preferably designed as at least one spring element. In one specific embodiment, the spring element is configured as a dome-shaped spring, alternatively a helical spring or the like being possible. The return element, in particular the spring element, most particularly the dome-shaped spring, enables a direct haptic feedback during the actuation of the operating element and/or of the further operating element, whereby the user comfort is enhanced.

The work location illumination unit includes the illuminant and the light guiding element. The work location illumination unit is designed to emit light. The light is furthermore preferably emitted to a work location situated directly in front of the hand-held power tool. An illumination of the work location as well as of the exchangeable insertion tool may take place in the process. For example, the illuminant may be at least one LED.

The illuminant emits the light. The light guiding element is designed to guide light. The light guiding element is furthermore provided to refract the light and guide it to the work location. The light guiding element may preferably be designed as a light focusing element, in particular a focusing lens. It is possible that the illuminant and the light guiding element are designed in one piece, and that, in one specific embodiment, the at least one LED forms the light-focusing element, in particular the focusing lens.

The housing preferably includes at least one power supply holding device, in particular a hand-held power tool rechargeable battery pack holding device, at which the user interface is situated. The power supply holding device is, in particular, designed to hold, in particular accommodate, the power supply, in particular the hand-held power tool rechargeable battery pack. The power supply holding device is additionally provided to detachably connect the power supply, in particular the hand-held power tool rechargeable battery pack, to the housing in a tool-less manner, and to ensure the power supply of the hand-held power tool. The power supply holding device, together with a connected hand-held power tool rechargeable battery pack, forms at least one base including at least one standing surface. In particular, the hand-held power tool may be supported, in particular set, on a standing surface with the aid of the base. The housing moreover includes a handle. The handle is designed to be gripped by the user to use the hand-held power tool. The power supply holding device is, in particular, situated at the handle.

The user interface is advantageously situated at the power supply holding device. In particular, the user interface is situated at the power supply holding device in such a way that the work location illumination unit is able to provide the user interface with preferably extensive illumination of the work location.

As an alternative, the user interface may also be situated at the handle, in particular in the area of the manual switch, or else at a tool holder.

The drive unit may be connected to an output shaft via the striking mechanism. The tool holder is formed at a free end of the output shaft, in particular in a direction pointing away from the drive unit. The tool holder is provided to accommodate exchangeable insertion tools. The tool holder may be configured as a chuck, but also as a polygonal internal holder or as a polygonal external holder. Typical examples of tool holders are sufficiently conventional in the related art, which is why they are not addressed in greater detail here.

The user interface preferably includes at least one carrier element, which is designed to carry a user interface and to transfer occurring operating forces into the housing. In one specific embodiment, the carrier element may accommodate the user interface. The carrier element may accommodate the user interface in a form-locked, force-fit and/or integral manner and establish an operative connection with the housing. When the operating element of the user interface is actuated by the user, operating forces may arise. These operating forces are absorbed by the user interface and subsequently passed on to the carrier element. The carrier element preferably absorbs these operating forces and passes them on to the housing. The carrier element is operatively connected to the housing for this purpose. In particular, the user interface is accommodated by a recess of the housing and attached to the housing. The housing is designed in the process to absorb the operating forces. The operating forces may, for example, arise as a result of pushing, sliding, pulling or turning the operating element.

The carrier element is, in particular, designed as at least one operating carrier element and/or as at least one light guiding carrier element. The operating carrier element carries at least the operating element. In particular, the operating carrier element may form the operating element. In one specific embodiment, the operating carrier element, together with the operating element, may be designed in the manner of a keypad, one specific embodiment in the manner of a circuit board including mechanical switches or pushbuttons also being possible. In one embodiment in the manner of a keypad, the operating carrier element represents a closed system with the operating element. The closed system offers the advantage that an ingress of moisture and dirt into the keypad is prevented, so that an IP protection class of up to IP54, in particular IP64, may be achieved. The operating carrier element is furthermore provided to pick up signals, which arise as a result of the actuation of the operating element, from the operating element and to forward them. In particular, the operating carrier element forwards the signals to the signal processing unit. The operating carrier element is additionally designed to absorb the operating forces from the operating element.

The light guiding carrier element may absorb the operating forces which arise as a result of the actuation of the operating element and pass them on to the housing. For this purpose, the light guiding carrier element includes a base plate. The base plate is in direct and indirect contact with the housing. In particular, the base plate absorbs the operating forces and passes them on to the housing. The light guiding carrier element furthermore carries at least the light guiding element and aligns it at the housing. In particular, the light guiding carrier element is designed to situate the light guiding element at the housing in such a way that the light guiding element is situated in a suitable manner with respect to the illuminant and the work location. In this way, optimal illumination of the work location is made possible during the operation of the hand-held power tool.

One specific embodiment of the present invention provides that an operating carrier element and a light guiding carrier element are present. The light guiding carrier element carries the operating carrier element. The light guiding carrier element may be attached to the housing. The light guiding carrier element thus absorbs the operating forces which act on the operating carrier element during the actuation of the operating element, and transfers them into the housing.

In particular, the operating carrier element and/or the light guiding carrier element may include the display element. The operating carrier element preferably includes the display element for displaying the pieces of information, as described above.

In a particularly preferred manner, the operating carrier element is attached to the light guiding carrier element. In one specific embodiment, the operating carrier element and the light guiding carrier element may also be detachably as well as non-detachably attached to one another. The operating carrier element and the light guiding carrier element may establish a form-locked, force-fit, and/or integral joint in the process. For example, the operating carrier element and the light guiding carrier element may be joined to one another with the aid of a screw joint, a snap joint, an adhesive joint or a clamped joint, further joining types which appear useful to those skilled in the art being possible. The operating carrier element and the light guiding carrier element are preferably glued to one another.

The light guiding carrier element advantageously includes at least one receptacle for an electrical contacting of the user interface. The receptacle may, for example, be designed as a feedthrough element, preferably a feedthrough opening, or as a recess in the process. In one specific embodiment, the electrical contacting of the user interface with the signal processing unit is created by at least one signal line. The signal line is provided to electrically contact the user interface with the signal processing unit. In one specific embodiment, the operating carrier element and/or the operating element may include the signal line. In one specific embodiment, the signal line is connected to the operating carrier element and/or at the operating element. It is also possible that the signal line is integral with the operating carrier element. The signal line is connected to the signal processing unit. The receptacle accommodates the signal line for this purpose. The feedthrough opening may preferably feed through the signal line.

The signal processing unit may include a connecting element for the connection to the signal line. The connection from the signal line to the connecting element may be detachable, but also non-detachable. By way of example, the connecting element is configured as a plug-in coupling. However, it is also possible that the signal line is directly connected to the signal processing unit with the aid of a soldered joint. The signal line is provided to pick up signals which arise as a result of the actuation of the operating element and to forward them to the signal processing unit. Moreover, the signal line may forward the output signals from the signal processing unit to the user interface. The display element may furthermore be connected to the signal processing unit with the aid of the signal line.

In one alternative specific embodiment of the present invention, the user interface is directly connected to the signal processing unit, in particular the connecting element. For this purpose, the user interface may include plug contacts, for example, which are connectable to the connecting element.

In a particularly advantageous manner, the light guiding carrier element includes at least one volume equalization element at least for the operating element. In particular, the volume equalization element is configured at the light guiding carrier element. In one specific embodiment of the present invention, the volume equalization element is designed as at least one recess, in particular a groove. The volume equalization element is designed to equalize at least one volume. In particular, the volume equalization element may also be provided to equalize at least one temperature and/or at least one pressure. The volume equalization element is operatively connected to the operating element, so that an operating pressure may be equalized with the aid of the volume equalization element during the actuation of the operating element. The operating pressure may arise between the operating carrier element and the light guiding carrier element during the actuation of the operating element. Moreover, the volume equalization element may be operatively connected to the display element. The display element may heat up during use, and, in one specific embodiment of the present invention, this heat may be equalized with the aid of the volume equalization element.

The carrier element, in particular the light guiding carrier element, preferably includes at least one recess through which the at least one light guiding element is feedable. The recess may be designed as at least one feedthrough element, in particular a feedthrough opening. In one specific embodiment of the present invention, the light guiding carrier element and the light guiding element are configured in two pieces for this purpose.

The light guiding element is particularly preferably attached to the carrier element, in particular the light guiding carrier element. In one specific embodiment of the present invention, the light guiding element is attached to the carrier element, in particular the light guiding carrier element, in a form-locked, force-fit and/or integral manner. For example, the attachment may be established with the aid of a snap joint, a screw joint, a clamped joint, an adhesive joint, or another joining type which appears useful to those skilled in the art. The light guiding element and the carrier element may be designed in two pieces in the process.

In one preferred specific embodiment of the present invention, the carrier element, in particular the light guiding carrier element, and the light guiding element are designed in one piece. In this way, a cost-effective and reliable user interface may be provided. In particular, a reliable joint of the carrier element, in particular the light carrier element, and the light guiding element may be made possible.

The operating carrier element advantageously at least partially encloses the light guiding element. In this way, a compact and cost-effective user interface may be provided.

The carrier element, in particular the light guiding carrier element, preferably includes a mounting unit for mounting the user interface at the housing of the hand-held power tool. The mounting unit is designed to mount the user interface at the housing. In one specific embodiment of the present invention, the mounting unit may be configured at the carrier element, in particular the light carrier element, for example as an at least partially circumferential frame and/or as an at least partially circumferential web. The mounting unit is preferably integral with the carrier element, in particular the light carrier element.

The mounting unit particularly preferably includes a first at least partially circumferential mounting element, and the housing includes at least one at least partially circumferential holding element. The first mounting element and the holding element form an operative connection for vertically mounting the user interface. In one specific embodiment of the present invention, the first mounting element is configured as an at least partially circumferential web, and is molded at the carrier element, in particular the light carrier element. For example, the first mounting element may be joined to the carrier element, in particular the light carrier element, in a form-locked, force-fit and/or integral manner. The holding element is designed to hold at least the first mounting element at the housing. In particular, the holding element is joined at least in a form-locked and/or force-fit manner to the first mounting element. In one specific embodiment of the present invention, the holding element may be configured as at least one protrusion at the housing, so that the holding element forms a form fit with the first mounting element. In one other specific embodiment of the present invention, the holding element, for example, may be formed to be at least partially elastically deformable, so that the holding element forms a force fit with the first mounting element. The holding element is preferably integral with at least a portion of the housing.

In one specific embodiment of the present invention, the holding element fixes the first mounting element at least in a force-fit manner, in particular for vertically mounting the user interface. The holding element may clamp the carrier element to the housing with the aid of the first mounting element, and thereby establish a clamped joint. In this way, a secure and reliable actuation of the user interface is made possible. The vertical mounting shall be understood relative to a reference plane here. The reference plane is the base plate of the light guiding carrier element. In one alternative specific embodiment of the present invention, the first mounting element is joined to the holding element with the aid of a screw joint, a snap joint or a further joining type which appears useful to those skilled in the art.

The mounting unit most preferably includes a second at least partially circumferential mounting element, and the housing includes at least one at least partially circumferential setting element. The second mounting element and the setting element form an operative connection for horizontally mounting the user interface. In one specific embodiment of the present invention, the second mounting element is designed as an at least partially circumferential frame. The second mounting element is situated at the carrier element, in particular the light carrier element. By way of example, the second mounting element may be joined to the carrier element, in particular the light carrier element, in a form-locked, force-fit and/or integral manner. The setting element is designed to fixedly set at least the second mounting element at the housing. In one specific embodiment of the present invention, the setting element is configured by at least a portion of the housing. In particular, the setting element may be configured as at least one further protrusion at the housing. It is also possible that the setting element is integral with at least a portion of the housing. The setting element is designed to be joinable at least in a form-locked and/or force-fit manner to the second mounting element. In one specific embodiment of the present invention, the setting element sets the second mounting element at least in a form-locked manner for horizontally mounting the user interface. In this way, a secure and reliable mounting of the user interface is made possible. The horizontal mounting shall be understood relative to the reference plane here, in particular the base plate of the light guiding carrier element. However, it is also possible that the second mounting element is joined to the setting element with the aid of a clamped joint, a snap joint, an adhesive joint or a further joining type which appears useful to those skilled in the art.

### BRIEF DESCRIPTION OF THE DRAWINGS

The present invention is described hereafter based on preferred specific embodiments of the present invention.

FIG. 1 shows a schematic view of a hand-held power tool according to an example embodiment of the present invention including a user interface.

FIG. 2 shows a perspective section of the hand-held power tool including the user interface.

FIG. 3 shows a sectional view of the user interface at the hand-held power tool.

FIG. 4 shows a perspective view of the user interface.

FIG. 5a shows a perspective view of a light guiding element including a light guiding carrier element.

FIG. 5b shows a perspective view of an operating carrier element including an operating element and a further operating element.

FIG. 6a shows a top view of a first alternative specific embodiment of the user interface.

FIG. 6b shows a top view of a second alternative specific embodiment of the user interface.

FIG. 6c shows a schematic sectional view of a third alternative specific embodiment of the user interface.

FIG. 6d shows a schematic sectional view of a fourth alternative specific embodiment of the user interface.

### DETAILED DESCRIPTION OF EXAMPLE EMBODIMENTS

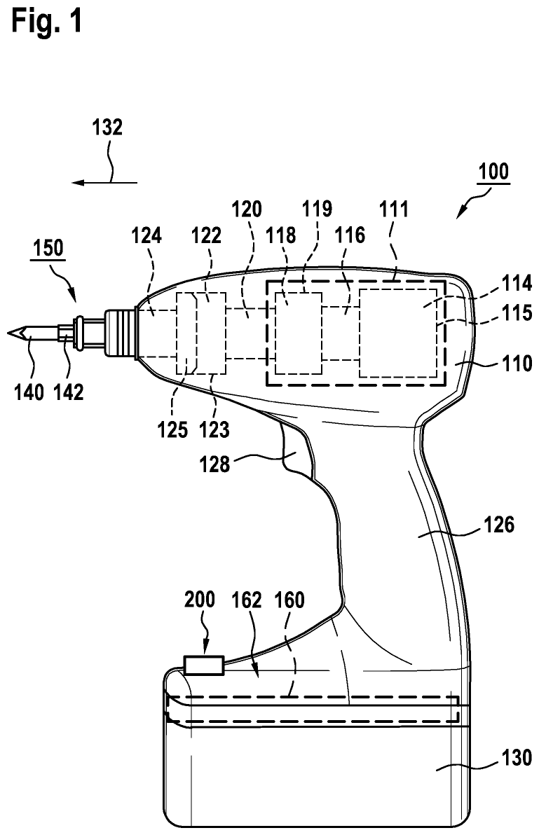

FIG. 1 shows a hand-held power tool 100 according to the present invention, designed as an exemplary rechargeable battery rotary impact screw driver here. Hand-held power tool 100 includes an output shaft 124, a tool holder 150, and an exemplary striking mechanism 122, e.g., a rotary or rotational striking mechanism. Hand-held power tool 100 includes a housing 110, including a handle 126. For a mains-independent power supply, hand-held power tool 100 is mechanically and electrically connectable to a power supply for a rechargeable battery operation, so that hand-held power tool 100 is designed as a rechargeable battery-operated hand-held power tool 100. A hand-held power tool rechargeable battery pack 130 serves as the power supply here. However, the present invention is not limited to rechargeable battery-operated hand-held power tools, but may also be used in mains-dependent, i.e., mains-operated, hand-held power tools or pneumatically operated hand-held power tools.

Housing 110 illustratively includes a drive unit 111 and striking mechanism 122. Drive unit 111 furthermore includes an electric drive motor 114, which is supplied with power by hand-held power tool rechargeable battery pack 130, and a gearbox 118. Gearbox 118 may be designed as at least one planetary gear. Drive motor 114 is designed so that it is actuatable via a manual switch 128, for example, so that drive motor 114 may be switched on and off. Drive motor 114 may be any arbitrary motor type, such as for example an electronically commutated motor or a DC motor. Drive motor 114 is advantageously electronically controllable and/or regulatable, so that a reversing operation as well as desired rotational speed are implementable. The design and the functionality of a suitable drive motor are sufficiently conventional to those skilled in the art, which is why this is not addressed in greater detail here.

Gearbox 118 is connected to drive motor 114 via a motor shaft 116. Gearbox 118 is provided to convert a rotation of motor shaft 116 into a rotation between gearbox 118 and striking mechanism 122 via a drive member 120, for example a drive shaft. This conversion preferably takes place in such a way that drive member 120 rotates relative to motor shaft 116 at increased torque, but at a reduced rotational speed. A motor housing 115 is illustratively assigned to drive motor 114, as a gear housing 119 is assigned to gearbox 118. Motor housing 115 and gearbox housing 119 are situated in housing 110 by way of example. However, it is also possible that drive motor 114 and gearbox 118 may be situated directly in housing 110 when hand-held power tool 100 has an “open frame” design.

Striking mechanism 122 is connected to drive member 120 and, by way of example, includes a striking body 125, which generates strike-like angular momentum with high intensity. This strike-like angular momentum is transmitted via striking body 125 to output shaft 124, for example a working spindle. Striking mechanism 122 includes a striking mechanism housing 123, it also being possible for striking mechanism 122 to be situated in another suitable housing, such as for example gearbox housing 119. The exemplary striking mechanism 122 is designed to drive output shaft 124. A tool holder 150 is provided at output shaft 124. Tool holder 150 is preferably molded and/or configured at output shaft 124. Tool holder 150 is preferably situated in an axial direction 132 pointing away from drive unit 111. Tool holder 150 is designed as an internal hexagon holder, in the manner of a bit holder, here, which is provided to accommodate an insertion tool 140. The insertion tool is configured in the manner of a screwdriver bit having a polygonal external coupling 142. The manner of the screwdriver bit, for example according to the HEX type, is sufficiently conventional to those skilled in the art. However, the present invention is not limited to a use of HEX screwdriver bits, but further tool holders which appear useful to those skilled in the art may also be used, such as for example HEX drills or SDS-Quick insertion tools. In addition, the design and the functionality of a suitable bit holder are sufficiently conventional to those skilled in the art.

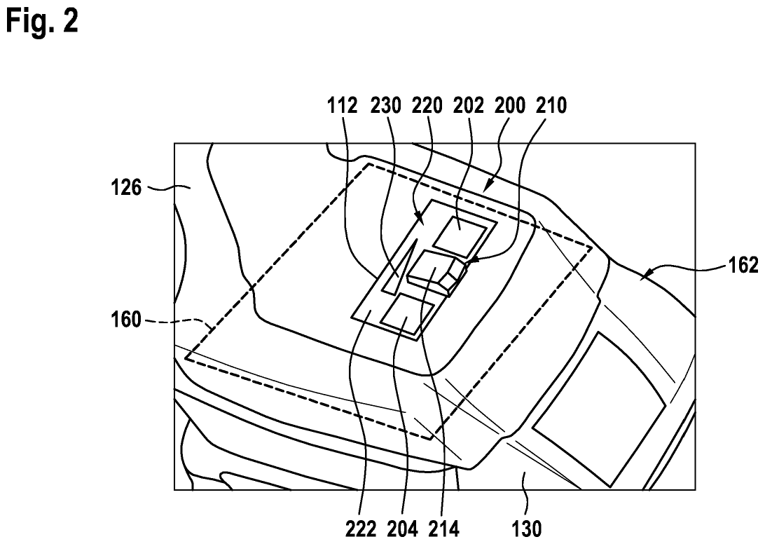

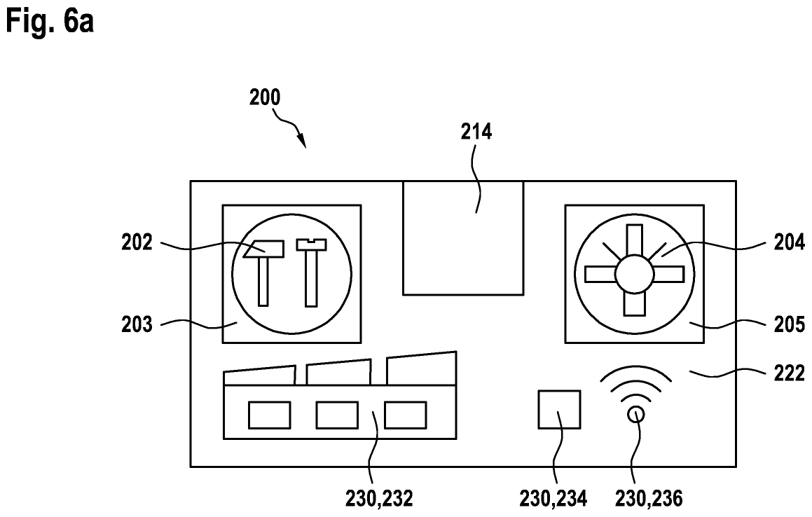

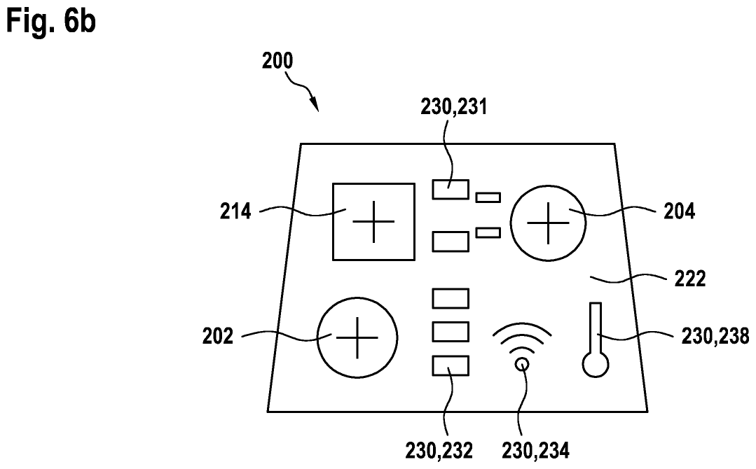

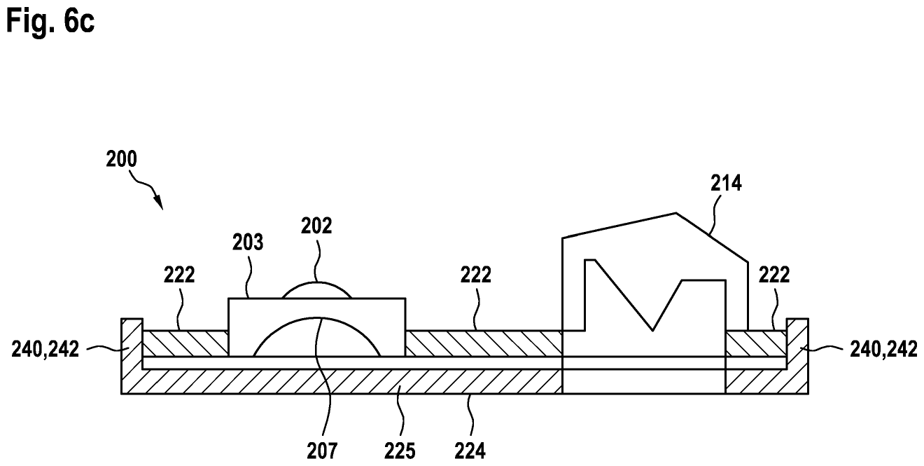

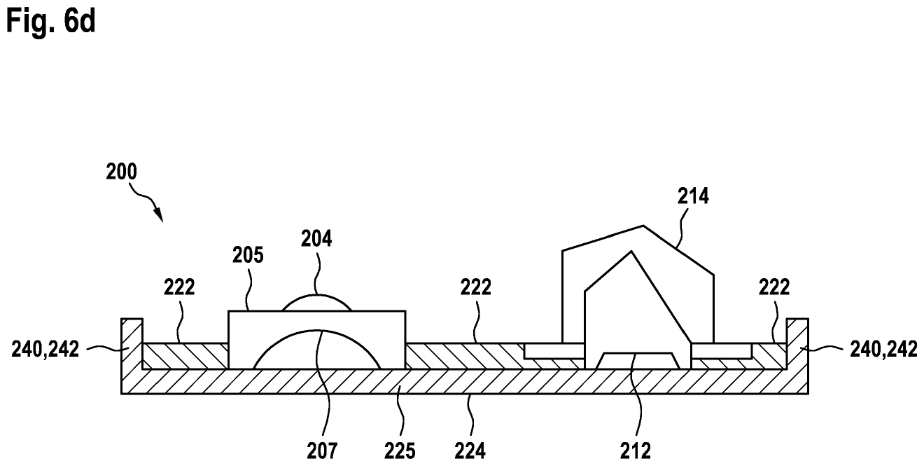

Hand-held power tool 100 includes housing 110 and a user interface 200 according to the present invention. User interface 200 includes an operating element 202 and a further operating element 204, and a work location illumination unit 210; see also FIGS. 2 through 6. Operating element 202 and further operating element 204 each include a return element in the form of a dome-shaped spring 207; see FIGS. 6c and 6d in this regard. User interface 200 is situated at housing 110.

Housing 110 includes drive unit 111, manual switch 128, the power supply, designed as a hand-held power tool rechargeable battery pack 130 here, and user interface 200. Housing 110 moreover includes a power supply holding device 160. User interface 200 is furthermore situated at power supply holding device 160. Power supply holding device 160 accommodates hand-held power tool rechargeable battery pack 130, and forms a base 162 including a standing surface in the process. Hand-held power tool rechargeable battery pack 130 is detachable from power supply holding device 160 in a tool-less manner. Housing 110 furthermore includes handle 126 and power supply holding device 160. Handle 126 may be gripped by the user. In one specific embodiment of the present invention, power supply holding device 160 is situated at handle 126. Hand-held power tool 100 may be set down with the aid of base 162. In this specific embodiment of the present invention, user interface 200 is situated at power supply holding unit 160.

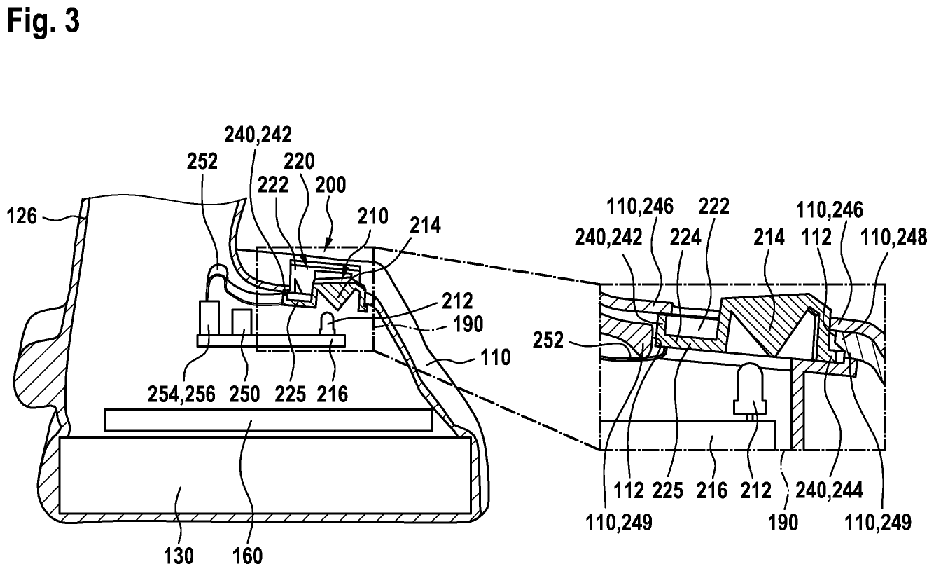

FIG. 2 represents a perspective section of hand-held power tool 100 including user interface 200. Work location illumination unit 210 includes an illuminant 212 and a light guiding element 214; see also FIG. 3 in this regard. Work location illumination unit 210 emits a light beam for illuminating a work location situated directly in front of hand-held power tool 100, as well as possibly exchangeable insertion tool 140.

User interface 200 includes operating element 202 and further operating element 204. Operating element 202 is used to set an operating mode, in this embodiment a rotational speed level. Further operating element 204 controls and/or regulates work location illumination unit 210. Further operating element 204 switches work location illumination unit 210 on or off. As described at the outset, it is also possible that operating element 202 changes another operating mode. Operating element 202 as well as further operating element 204 are each designed as a pusher element, which may be pushed by the user.

User interface 200 moreover includes a carrier element 220. Carrier element 220 carries user interface 200 and transfers occurring operating forces into housing 110. Carrier element 220 is configured as an operating carrier element 222 and as a light guiding carrier element 224; see also FIGS. 3, 4 and 6. Operating carrier element 222 carries operating element 202 and further operating element 204. Light guiding carrier element 224 carries light guiding element 214; see also FIG. 3. User interface 200 additionally includes a display element 230. Display element 230 displays information about an operating mode, here the rotational speed level. In this specific embodiment of the present invention, operating carrier element 222 includes display element 230.

FIG. 3 shows a sectional view of user interface 200 at hand-held power tool 100. Moreover, a further enlarged detail 190 is shown in FIG. 3. User interface 200 is accommodated in a recess 112 of housing 110 and protrudes from recess 112. Work location illumination unit 210 includes illuminant 212 and light guiding element 214. Illuminant 212 is designed as an LED here. Light guiding element 214 is configured as a focusing lens. Illuminant 212 emits light. Light guiding element 214 focuses the light of illuminant 212 and guides it as a light beam in the direction of the work locations.

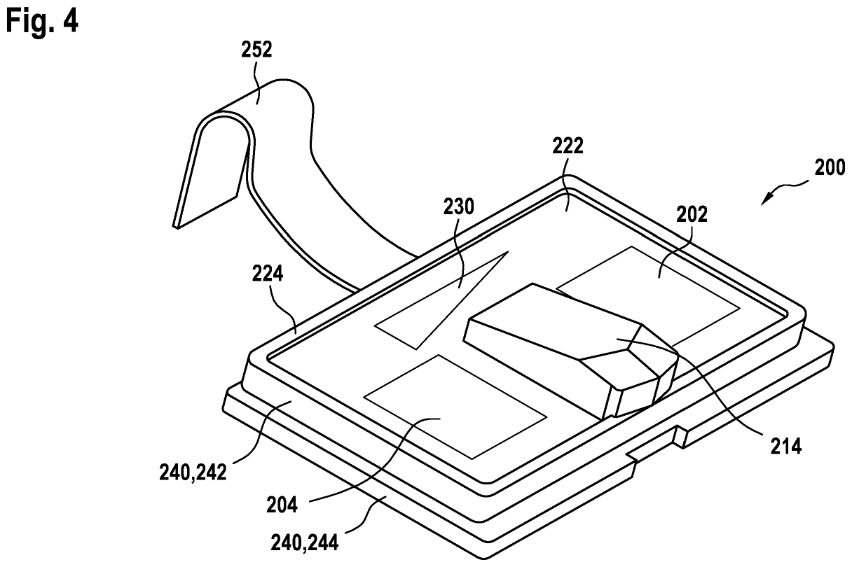

Light guiding carrier element 224 of user interface 200 carries light guiding element 214 and aligns it at housing 110. Light guiding carrier element 224 includes a mounting unit 240 for mounting user interface 200 at housing 110 of hand-held power tool 100; see also FIGS. 4 through 6. Mounting unit 240 includes a first circumferential mounting element 242; see also FIGS. 4 through 6. Housing 110 includes a holding element 246. First mounting element 242 forms an operative connection with holding element 246 for vertically mounting user interface 200. The vertical mounting is relative to a reference plane. In this specific embodiment, the reference plane is base plate 225 of light guiding carrier element 224. First mounting element 242 is configured as a circumferential web and designed in one piece with light carrier element 224. Holding element 246 is configured to be at least partially elastically deformable. Holding element 246 is formed of a soft grip material, which at least partially surrounds housing 110. Holding element 246 forms a protrusion, which extends around recess 112 and protrudes into recess 112, at housing 110. In this way, holding element 246 fixes first mounting element 242 at least in a force-fit manner for vertically mounting user interface 200.

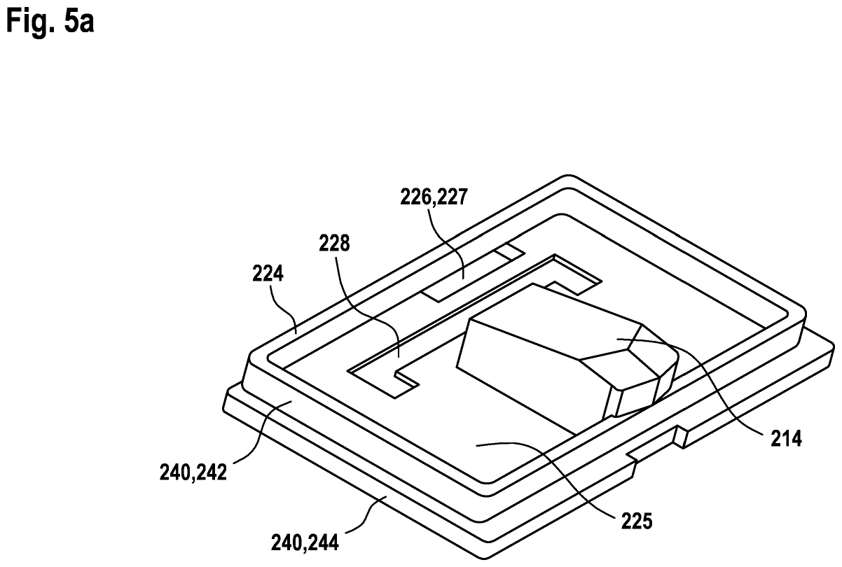

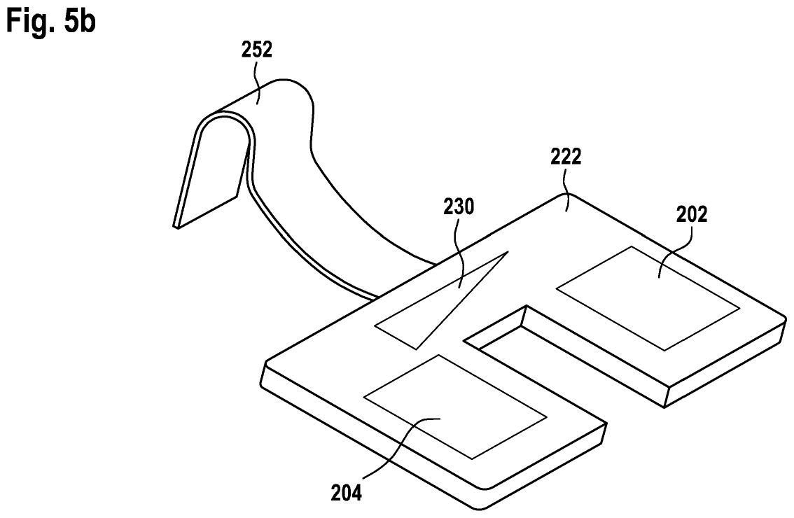

Mounting unit 240 moreover includes a second circumferential mounting element 244; see also FIGS. 4 and 5. Housing 110 includes a partially circumferential setting element 249. Second mounting element 244 forms an operative connection with setting element 249 for horizontally mounting user interface 200. The horizontal mounting is relative to the reference plane, base plate 225 of light guiding carrier element 224 here. Second mounting element 244 is configured as a frame on three sides of light guiding carrier element 224. Second mounting element 244 is furthermore designed in one piece with light carrier element 224. Setting element 249 fixedly sets second mounting element 244 at housing 110. Setting element 249 is formed at housing 110 by a hard component of housing 110. In this specific embodiment, setting element 249 is a circumferential frame. Setting element 249 fixedly sets second mounting element 244 in a form-locked manner for horizontally mounting user interface 200. In this specific embodiment, a section of first mounting element 242 is supported on setting element 249 for horizontally mounting light guiding carrier element 224. The hard component of housing 110 fixes second mounting element 244 in a form-locked manner in three sections 248 of recess 112 with the aid of an undercut for vertically mounting light guiding carrier element 224.

Hand-held power tool 100 includes a signal processing unit 250. Signal processing unit 250 is situated in housing 110. Signal processing unit 250 receives signals from user interface 200 and processes them. After the signals have been processed, signal processing unit 250 outputs the signals in the form of an output signal. Signal processing unit 250 is designed as a microprocessor here.

Light guiding carrier element 224 includes a receptacle 226 for an electrical contacting of user interface 200; see also FIG. 5a. Receptacle 226 is configured as a feedthrough opening 227. A signal line 252 establishes the electrical contacting of user interface 200 with signal processing unit 250. In this specific embodiment, operating carrier element 222 is connected to signal line 252; see also FIGS. 4 and 5b. Signal line 252 extends through feedthrough-opening 227 and connects user interface 200 to signal processing unit 250. Signal processing unit 250 includes a connecting element 254 for the connection to signal line 252. Connecting element 254 is configured as a plug-in coupling 256 here. In this way, signal line 252 is detachably connected to connecting element 254. In this specific embodiment, signal line 252 is configured at operating carrier element 222. Signal line 252 picks up signals which arise as a result of the actuation of the operating element and forwards them to signal processing unit 250. Signal line 252 furthermore forwards the output signals from signal processing unit 250 to user interface 200. Display element 230 is also connected to signal processing unit 250 with the aid of signal line 252 here. In this specific embodiment, connecting element 254, signal processing unit 250, and illuminant 212 are situated on a circuit board 216 and electrically connected to one another.

FIG. 4 represents a perspective view of user interface 200. Operating carrier element 222 is attached to light guiding carrier element 224. Operating carrier element 222 and light guiding carrier element 224 are joined with the aid of an adhesive joint here. Operating carrier element 222 has a c-shaped design and partially encloses light guiding element 224.

FIG. 5a shows a perspective view of light guiding carrier element 224 including light guiding element 214. In this specific embodiment, light guiding carrier element 224 and light guiding element 214 are integral. Light guiding carrier element 224 absorbs the operating forces arising as a result of the actuation of operating element 202 and/or of further operating element 204, and passes them on to the housing 110. Light guiding carrier element 224 includes a volume equalization element 228 for operating element 202, further operating element 204, and for display element 230. Volume equalization element 228 is configured at light guiding carrier element 224. Volume equalization element 228 is designed as a c-shaped groove. Volume equalization element 228 equalizes a temperature and/or a pressure. Volume equalization element 228 is operatively connected to operating element 202 and further operating element 204. It equalizes an operating pressure during the actuation of operating element 202 and/or further operating element 204, which may arise between operating carrier element 222 and light guiding carrier element 224.

FIG. 5b shows a perspective view of operating carrier element 222 including operating element 202 and further operating element 204. In addition, display element 230 and signal line 252 are shown. Operating carrier element 222 including operating element 202 and further operating element 204 may be designed in the manner of a keypad here. Operating carrier element 222 absorbs the operating forces from operating element 202 and/or from further operating element 204, which arise as a result of the actuation. Operating carrier element 222 additionally passes the operating forces on to light guiding carrier element 224.

FIG. 6a shows a top view of a first alternative specific embodiment of user interface 200. Operating element 202 and further operating element 204 each include a printed area 203, 205. Printed area 203, 205 is designed in each case on an operating surface of operating element 202 and of further operating element 204. Printed area 203, 205 displays a function of operating element 202 and of further operating element 204 to the user. The function for further operating element 204 is displayed on the operating surface in the form of a bulb. The function for operating element 202 is displayed on the operating surface in the form of a hammer with a screw.

The first alternative specific embodiment furthermore shows display element 230 in the form of a rotational speed display element 232. Rotational speed display element 232 includes three LEDs for displaying the set rotational speed level. In addition, display element 230 is configured as a radio link display element 234. Radio link display element 234 displays to the user whether an active radio link is present between hand-held power tool 100 and a further electrical device. Radio link display element 234 is designed as an LED. In addition, display element 230 is configured as a symbol 236 here for displaying a wireless connection. Here, it is to be shown to the user that hand-held power tool 100 is able to establish a wireless connection.

FIG. 6b shows a top view of a second alternative specific embodiment of user interface 200. In contrast to FIG. 6a, display element 230 is additionally designed as a work location illumination display element 231 and as a temperature display element 238 here. Work location illumination display element 231 displays to the user whether work location illumination unit 210 is switched on or switched off. Work location illumination display element 231 is designed as two LEDs here. Temperature display element 238 displays a temperature of hand-held power tool 100 to the user. It is designed as an LED.

FIG. 6c shows a schematic sectional view of a third alternative specific embodiment of user interface 200. In the third alternative specific embodiment, operating carrier element 222 includes light guiding element 214. Light guiding element 214 is connected to operating carrier element 222. In this specific embodiment as well, operating carrier element 222 is attached to light guiding carrier element 224.

FIG. 6d shows a schematic sectional view of a fourth alternative specific embodiment of the user interface 200. As in the third alternative specific embodiment, operating carrier element 222 includes light guiding element 214 and is joined thereto. In contrast to the third alternative specific embodiment, illuminant 212 is situated on light guiding carrier element 224. In this specific embodiment as well, operating carrier element 222 is attached to light guiding carrier element 224.

1-15. (canceled)

16. A hand-held power tool, comprising:
a drive unit actuatable using at least one manual switch;
a housing; and
at least one user interface, the user interface including at least one operating element and at least one work location illumination unit, the work location illumination unit including at least one illuminant and at least one light guiding element.

17. The hand-held power tool as recited in claim 16, wherein the user interface includes at least one carrier element which is configured to carry the user interface and to transfer occurring operating forces into the housing.

18. The hand-held power tool as recited in claim 17, wherein the carrier element is configured as: (i) at least one operating carrier element, the operating carrier element carrying at least the operating element, and/or (ii) at least one light guiding carrier element, the light guiding carrier element carrying at least the light guiding element.

19. The hand-held power tool as recited in claim 18, wherein the light guiding carrier element includes at least one receptacle for an electrical contacting of the user interface.

20. The hand-held power tool as recited in claim 18, wherein the light guiding carrier element includes at least one volume equalization element at least for the operating element.

21. The hand-held power tool as recited in claim 18, wherein the light guiding carrier element includes at least one recess through which at least the light guiding element is feedable.

22. The hand-held power tool as recited in claim 18, wherein the light guiding element is attached to the light guiding carrier element.

23. The hand-held power tool as recited in claim 18, wherein the light guiding carrier element and the light guiding element are designed in one piece.

24. The hand-held power tool as recited in claim 18, wherein the light guiding carrier element includes at least one mounting unit configured to mount the user interface at the housing of the hand-held power tool.

25. The hand-held power tool as recited in claim 24, wherein the mounting unit includes a first at least partially circumferential mounting element, and the housing includes at least one at least partially circumferential holding element, the first mounting element and the holding element establishing an operative connection for vertically mounting the user interface.

26. The hand-held power tool as recited in claim 25, wherein the mounting unit includes a second at least partially circumferential mounting element, and the housing includes at least one at least partially circumferential setting element, the second mounting element and the setting element establishing an operative connection for horizontally mounting the user interface.

27. The hand-held power tool as recited in claim 18, wherein the operating carrier element is attached to the light guiding carrier element.

28. The hand-held power tool as recited in claim 16, wherein the operating element is used to at least: (i) set a rotational speed level, and/or (ii) at least to control and/or regulate the work location illumination unit.

29. The hand-held power tool as recited in claim 16, wherein the user interface includes at least one further operating element, the further operating element being used to at least: (i) set a rotational speed level, and/or (ii) control and/or regulate the work location illumination unit.

30. The hand-held power tool as recited in claim 16, wherein the housing includes at least one hand-held power tool rechargeable battery pack holding device at which the user interface is situated.
